(19) United States
(12) Patent Application Publication
(10) Pub. No.: US 2011/0116416 A1
(43) Pub. Date: May 19, 2011

(54) System and method for geographically optimized wireless mesh networks

(76) Inventors: Eric L. Dobson, Knoxville, TN (US); Joel K. Reed, Knoxville, TN (US)

(21) Appl. No.: 12/927,471

(22) Filed: Nov. 16, 2010

Related U.S. Application Data
(60) Provisional application No. 61/281,443, filed on Nov. 18, 2009.

(51) Int. Cl. H04L 12/28; G06F 15/16

(52) U.S. Cl. 370/255; 709/208; 709/249

(57) ABSTRACT

A geographically optimized wireless mesh network comprises: a radio communications device to intelligently route information through a tracking, sensing, or communications network; a sensing device to sense conditions affecting the device or associated items; and, a communication system configured to transmit the output of the sensing device to a system administrator located remotely from the container. The geographically optimized wireless mesh devices may be capable of two-way communication with the system administrator, whereby the administrator may interrogate the devices at selected times. The locking device contains redundant location determination technologies whereby its geographic location is used to optimize the node and network performance.

### CROSS-REFERENCE TO RELATED APPLICATION

This application claims the benefit of Provisional Patent Application No. 61/281,443 by the present inventors, filed on Nov. 18, 2009, the entire disclosure of which is incorporated herein by reference.

### BACKGROUND OF THE INVENTION

1. Field of the Invention

The invention pertains to apparatus and methods related to wireless mesh networks. More particularly, the invention relates to peer-to-peer networking of wireless devices in commercial, industrial, and consumer environments.

2. Description of Related Art

Mesh networking is a type of networking where each node in the network may act as an independent router, regardless of whether it is connected to another network or not. It allows for continuous connections and reconfiguration around broken or blocked paths by daisy-chaining from node to node until the destination is reached. Mesh networks differ from other networks in that the component parts can all connect to each individual node in the network, as shown schematically in FIG. 1 for the case of eight nodes N. As the number of nodes N increases in an ad hoc network, overpopulation in a given area can lead to communication difficulties, as shown schematically in FIG. 2.

Mesh networks can fixed or mobile. Each device in a mobile ad hoc network (MANET) is free to move independently in any direction, and will therefore be presumed to change its links to other devices frequently. Each must forward traffic unrelated to its own use, and therefore be a router. The primary challenge in building a MANET is equipping each device to continuously maintain the information required to properly route traffic and extended performance due to battery limitations, all dependent on the duty cycle of the mobile device and the data requirements of the network. Mesh networks are self-healing: the network can still operate when one node breaks down or a connection goes bad. As a result, the network may typically be very reliable, as there is often more than one path between a source and a destination in the network. Although mostly used in wireless scenarios, this concept is also applicable to wired networks and software interaction.

In actual practice, physical obstacles and multipath interference will usually prevent one or more of the nodes from communicating successfully with the entire network.

In a MANET, over population is difficult or impossible to control due to the mobile nature of the radio nodes. Latency or actual loss of data can occur in over populated mesh networks. Battery powered mobile radio nodes can be quickly drained of power by the overhead of maintaining a large mesh network.

Various techniques have been proposed for managing communications when multiple receivers or devices such as cellular phones are used. Newberg et al., in U.S. Pat. No. 7,808,948, disclose a method for informing mobile stations of a control channel architecture for a wireless communication system. Thro et al., in U.S. Pat. Nos. 5,940,768 and 5,864,764, disclose methods for configuring infrastructure transceivers based on RF operating circumstances and on location information. Baker, in U.S. Pat. No. 6,782,436, discloses methods for facilitating communication on a network, in which the physical location of each network device is used to associate a network address to the device.

Various techniques have been proposed for managing devices in certain ways based on their location. For example, Cook, in U.S. Pat. No. 7,194,278, describes methods for altering the functionality of a device based on location (such as disabling a mobile phone when the device is inside a church, theater, or the like). Chandley, in U.S. Pat. No. 7,355,506, discloses methods for disabling or remotely shutting down an electronic device if the device has been stolen or lost. Cannon et al., in U.S. Pat. No. 7,058,358 disclose a network device with a GPS receiver to provide location data to a network gatekeeper, so that, for instance, a wireless device outside of a predetermined boundary, such as a particular building or office, will be denied access to the network. Karaoguz, in U.S. Pat. No. 7,668,124, discloses the management of communications within a wireless personal area network by grouping the devices into two or more groups; communications between the devices may be governed by profiles assigned to the groups based on their locations within the WPAN.

### OBJECTS AND ADVANTAGES

Objects of the present invention include the following: providing a radio-based network comprising a wireless mesh network, either mobile for fixed, that relies upon position information and resulting geographic mapping of the network to intelligently route traffic; providing a means of improving reliability and reducing the duty cycles of nodes in the network, thereby extending/optimizing the functional life of nodes in the network; providing a means of reducing the material cost of the network through reduced battery size and complexity; providing a method for connecting sensors of varying types and configurations for detecting various conditions in and around the network nodes; and, providing a backhaul system that communicates to a hierarchical server network and/or the Internet for data aggregation, processing/analysis, storage, and presentation globally. These and other objects and advantages of the invention will become apparent from consideration of the following specification, read in conjunction with the drawings.

### SUMMARY OF THE INVENTION

According to one aspect of the invention, a wireless mesh network comprises: a plurality of peer devices in communication with one another and having the ability to forward selected information across the network to a backhaul, each of said peer devices further comprising a geographic information system to determine the location of said peer device; and, at least one network device that adjusts at least a part of the network topology based on the mapped location of said peer devices.

According to another aspect of the invention, a wireless mesh network comprises: a plurality of peer devices forming network nodes in communication with one another and each having at least one sensor to sense at least one condition affecting an item associated with said network node, each peer device further comprising a geographic information system to determine the location of said peer device; and, a system monitor, located remotely from said peer devices, said system monitor adjusting at least a part of the network topology based on the mapped location of said peer devices so that communication efficiency may be optimized.

According to another aspect of the invention, network controller server system for a geographically optimized wireless mesh network (GOWMN) comprises: a computational computer platform for the storage, retrieval, analysis, and presentation of data regarding geographic information; a first geographic information system application to determine the location and topology of GOWMN nodes; a second geographic information system application to configure the optimal network topology and push said topology information to the GOWMN network; an algorithm for determining localized time sequencing and time slicing for any GOWMN network/subnetwork; and, a system monitor to receive information from said network controller at selected times and provide said output to selected users.

According to another aspect of the invention, a method of operating a wireless mesh network comprises the steps of:

creating a network of peer devices, each peer device forming a node in said network, each peer device further comprising a geographic information system so that the physical location of each peer device is known;

establishing a first network topology based on the respective locations of said peer devices; and,

dynamically adjusting said topology to optimize communication efficiency.

### BRIEF DESCRIPTION OF THE DRAWINGS

The drawings accompanying and forming part of this specification are included to depict certain aspects of the invention. A clearer conception of the invention, and of the components and operation of systems provided with the invention, will become more readily apparent by referring to the exemplary, and therefore non-limiting embodiments illustrated in the drawing figures, wherein like numerals (if they occur in more than one view) designate the same elements. The features in the drawings are not necessarily drawn to scale.

FIG. 1 illustrates an ideal ad hoc mesh network, in this case containing eight routers or nodes.

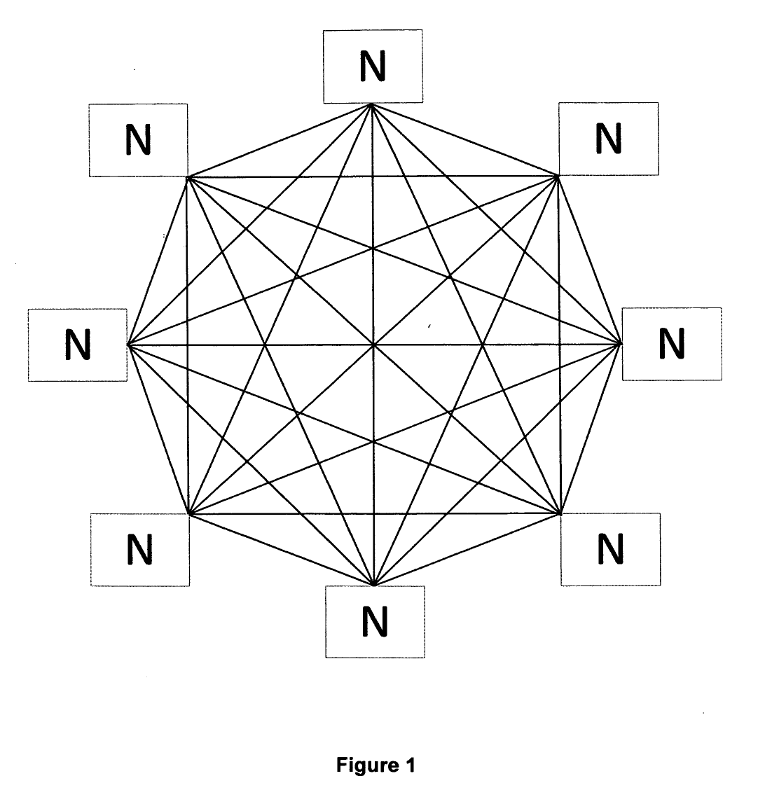

FIG. 2 illustrates a common problem with ad hoc mesh networks caused by “over population” in a given area, in this case involving sixteen nodes.

FIG. 3 illustrates conceptually one use of the inventive GOWMN, in which tracking devices are attached to containers in a shipyard.

FIG. 4 illustrates schematically the components of a typical node in a GOWMN.

### DETAILED DESCRIPTION OF THE INVENTION

The inventive Geographically Optimized Wireless Mesh Network (GOWMN) is a communications network made of location aware (GPS, dead reckoning, or radiolocation based) mobile devices connected by wireless links. Like the MANET, individual devices may be free to move independently in any direction but unlike the MANET, it is a centrally controlled topology and not ad hoc. This offers many advantages, as will become apparent from the various examples.

Because all of the radio nodes in the inventive GOWMN are location aware (preferably GPS equipped), a central server (or servers) is always aware of the physical location of the potential members of a network, and this enables the central control to determine all of the properties and responsibilities of the members of the network including time sequencing/slicing of the communications cycles of the individual nodes, and preferably, to change the network properties dynamically.

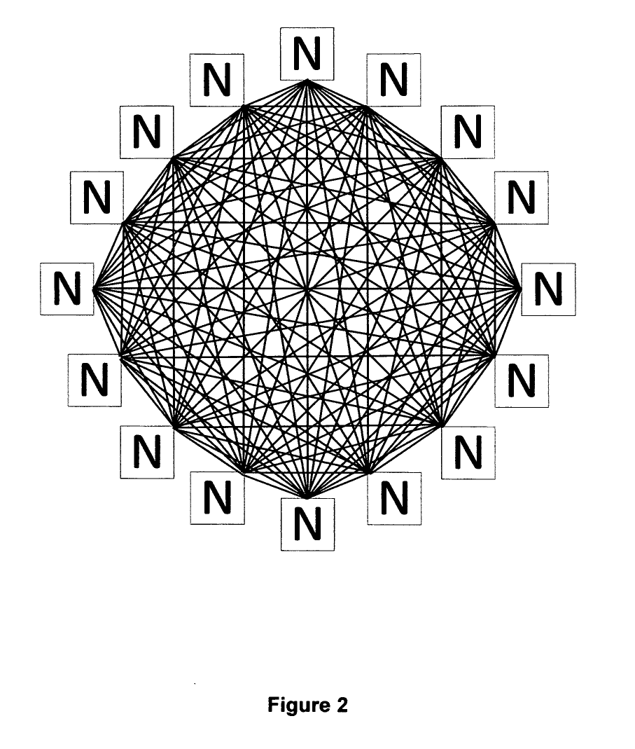

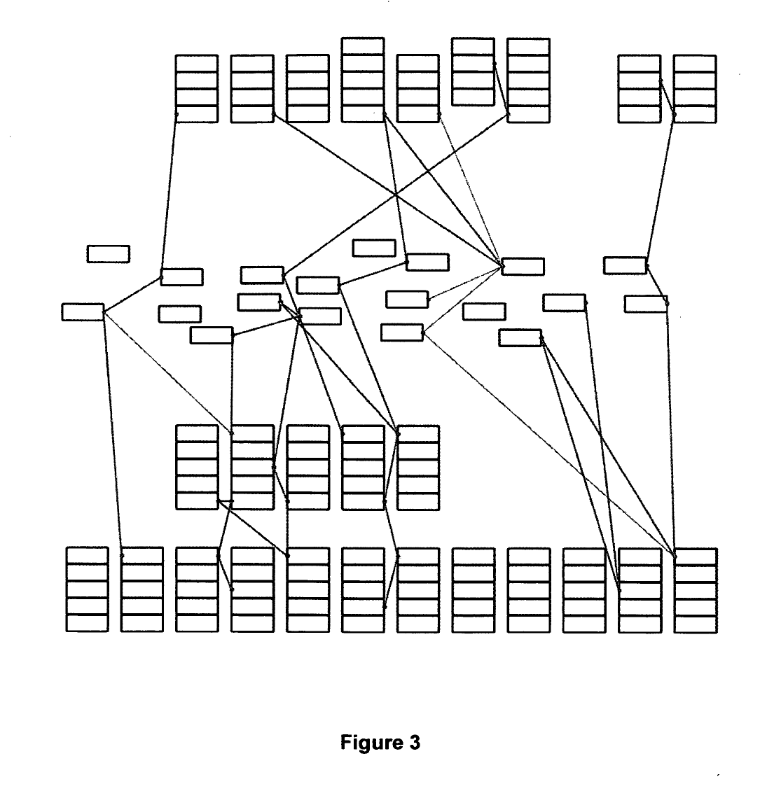

As shown, for example, in FIG. 3, one application might involve devices associated with individual cargo containers, illustrated by the rectangular boxes. Because the server can be made aware of the location and orientation of the containers in the yard, and the typical interference environment of any commonly used location can be empirically determined and stored in the server, an optimum network configuration can be resolved and pushed to the tracking devices. As can be seen in FIG. 3, the result is that not all of the nodes are communicating at once with all the other nodes but instead communication is managed selectively (indicated by dashed lines). Comparing this to the topology of FIG. 2, one can see that network overpopulation issues can be mitigated by the inventive approach.

Additionally, the topology of any set of GOWMN nodes is known. Each node can be dynamically configured to be a slave or master unit (parent or child) with any master reporting for any number of slaves and other masters in a hierarchical architecture. The determination of the network topology in the local area can be determined with mapping algorithms at the master node level with the inclusion of a microprocessor and geographic information system application capable of determining network and node topology.

### EXAMPLE

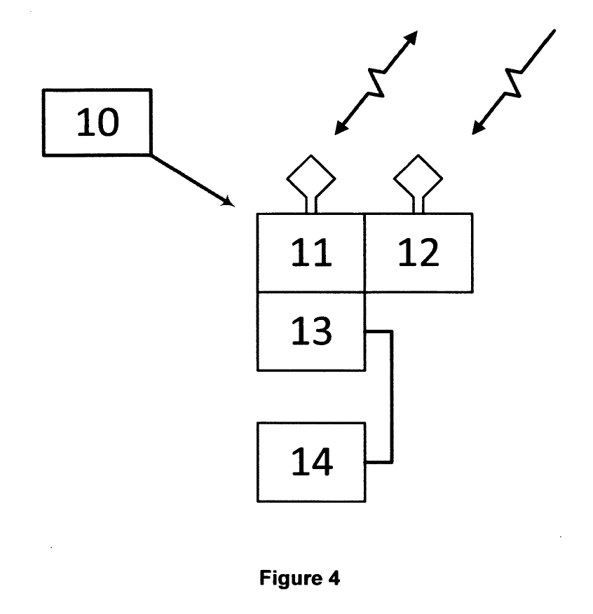

As shown schematically in FIG. 4, individual nodes 10 of the inventive GOWMN comprise at least the following elements: a wireless mesh network device 11, a geographic information device 12, a microprocessor 13, and a power source 14.

Some suitable wireless mesh network devices include the following:
1. ZMN2405HP manufactured by RF Monolithics, Inc., 4441 Sigma Road, Dallas, Tex. 75244
2. UZ2400 manufactured by Uniband Electronic Corporation, 6F-1, No. 192, Dongguang Rd., Hsinchu, 300 Taiwan
3. MRF24J40manufactured by Microchip Technology Inc., 2355 West Chandler Blvd., Chandler, Ariz., USA 85224-6199
4. 5131E-MCU or 8168B-MCU manufactured by AmTel, 2325 Orchard Parkway, San Jose, Calif. 95131
5. ZIC2410 manufactured by California Eastern Laboratories, 4590 Patrick Henry Drive, Santa Clara, Calif. 95054-1817
6. MC13192 manufactured by Freescale Semiconductor, Inc., Austin, Tex.
7. EM260 manufactured by Ember Corporation, 47 Farnsworth Street, Boston, Mass. 02210
8. CC2430 manufactured by Texas Instruments, 12500 TI Boulevard, Dallas, Tex.

The foregoing products are essentially RF transceivers that typically contain the following functions: power input and output; data input and output; memory; CPU; and firmware, that may be remotely updated, to coordinate and execute the device functions and transmit information between transceivers.

The geographic information device 12 may rely on a Global Positioning System; one suitable device is the ATR0601 GPS Front End IC, manufactured by Atmel Corp., 2325 Orchard Pkwy., San Jose, Calif. 95131. Other methods of determining the geographic location of the node may also be used, as will be further described in later examples.

A suitable microprocessor 13 is a CC2510 low power system on a chip with CPU, memory, and 2.4 GHz RF transceiver manufactured by Texas Instruments.

Individual nodes 10 will further typically include any number of accessory devices, which might comprise one or more functions such as various types of sensors, RFID tags, locks, etc., depending on particular applications and the contemplated working environment.

The invention combines a local area networking radio-based device(s) with a method(s) to intelligently route data through a network, in a peer-to-peer configuration, using the geographic location of the individual nodes, to a hierarchical backhaul system (including, but not limited to: the Internet, Radio Frequency Identification, cellular communications, and satellite communications). Each node is either fixed or mobile in nature, has a sensor interface to allow the detection of selected events or environmental factors, and is associated with one or more items about which sensors (including but not limited to: tilting, vibration, and tamper switches, air pressure, temperature and humidity sensors, and detectors for hazardous conditions such as the presence of chemical, biological, radiological, nuclear, and explosive agents), attached to the individual nodes can collect information on status, condition, location, and identification for the purpose of inventory, analysis, response, remote activation, and alerts in commercial, industrial, and consumer environments. Because the location of each node is known to the network, a local node with sufficient processing power (or a server) may assign communication paths and time slices/sequencing to the individual nodes in the network and may toggle individual nodes from/to slave or master position. One master node may report for any number of slave nodes. The GOWMN device may further incorporate, or be incorporated into, a geographically-based lock that prevents unauthorized opening of a container, of varying size and configuration associated with the network node, until the container has reached a selected destination, as described more fully in Applicants' co-pending U.S. patent application Ser. No. 12/460,961, entitled, “Shipping Container Having Integral Geolock System”, the entire disclosure of which is incorporated herein by reference.

In the examples that follow, it will become apparent that a geographically optimized mesh network provides a unique solution to many of the known concerns of the smart sensor, radio frequency identification, telematics, and shipping industries. Some of the noteworthy benefits include: 1. By intelligently routing data flow, the number of peer-to-peer communications is reduced, thereby extending the life of a mobile or fixed battery, fuel cell, or power scavenging operated radio-based device. 2. By using geography to map the network, fewer devices are needed to optimally cover a network environment. 3. The number of devices attempting to communicate at any given moment through time sequencing can be reduced in order to reduce radio-frequency and multipath interference in the network environment. 4. Inter-device communications required to sustain the network are reduced because the statistical likelihood of communication is increased. 5. Devices in the network may be toggled between the master and slave function providing intelligent routing of information in the network.

While wireless mesh networks using IEEE standard 802.15.4 are the current state of the art, their ad hoc nature tends to be less than ideal when high geographic node densities or very long battery life is required. The Geographically Optimized Wireless Network takes advantage of the current generation of small, inexpensive, and power efficient GPS receivers to allow each node in a member network to be spatially pinpointed at all times. Using this topographic information a server(s) can dynamically assign “master” and “slave” roles to wireless nodes, along with talk/listen windows and frequency/spread optimization. By eliminating the periodic transmissions required to maintain the integrity of 802.15.4 networks, battery life can be extended far beyond what is currently possible. Topographically optimized radio frequency parameters eliminate the need for complex collision avoidance systems, further reducing power consumption and maximizing the number of network nodes that can effectively operate in a confined geography location.

It will be appreciated that the invention mitigates many problems with traditional ad hoc networks by essentially creating an a priori network. While the ad hoc network functions relatively well with a small number of network nodes, as the number of nodes approaches those that could be found in certain industrial zones, such as a shipping terminal (i.e. tens of thousands), the radio activity necessary to maintain an ad hoc network increases in a nonlinear fashion (2 nodes: one connection, 3 nodes: three connections, 4 nodes: six connections, 5 nodes: ten connections, 6 nodes fourteen connections, etc.) Standard collision avoidance/correction techniques require constant monitoring of the activity on the network and/or frequent retransmission of lost data packets. In this scenario, data speed and reliability fall off dramatically while, at the same time, mobile power requirements (battery, solar, energy harvesting, etc) increase into commercially non-viable specifications. By creating an a priori network, as mobile wireless nodes move into a predefined geographical area(s), the ideal pre-characterized radio transmission parameters can be assigned to those mobile wireless nodes. If those pre-characterized radio transmission parameters define topographically optimized frequency/time/etc. restrictions, then the need for standard collision avoidance/correction measures are eliminated (or drastically reduced), as are lost data packets. The resulting increase in data throughput and reliability, and the reduction in power requirements make the a priori network vastly superior to the traditional ad hoc network.

Applicants contemplate that, with sufficient onboard memory and computing capacity, one or more of the peer devices may become a “super” node that may function as the “server” in situ with a direct backhaul to the satellite, cellular, or internet.

### EXAMPLE

Applicants' co-pending application describes a removable Access Bar configured to securely lock a shipping container. Applicants contemplate that in many applications, the Access Bar will be configured with a form factor that is compatible with certain characteristic dimensions of standard shipping containers. The Access Bar can operate in concert with any number of like Access Bars in the intermodal shipping industry. It is therefore desirable that these Access Bars have the ability to communicate in a peer-to-peer fashion in harsh wireless environments. A GOWMN is an ideal solution allowing these devices to conserve energy and to provide a data rich sensor feed to a hierarchical network globally. Although not shown in the drawings, it will be appreciated that the inventive concept may equally well be adapted to containers of other geometries with only routine engineering modifications. For example, the Access bar may be configured with a ring-like locking mechanism to grasp the rim of a standard drum or barrel, thereby preventing the barrel from being opened during transit. For example, the GOWMN may be configured with a modified Access Bar for a ruggedized man-portable case to prevent unauthorized assess to the contents.

### EXAMPLE

It is contemplated that in many smart sensor applications it will be preferable to have a wireless mesh network, being either fixed or mobile. Such smart sensors, once mapped by either manual or automated means (GPS, dead reckoning, radiotriangulation, etc.) may be optimally organized and data aggregated for reporting across a distributed network in industrial, commercial, or consumer environments using a GOWMN. The device may allow for wireless communication with a variety of sensor (chemical, biological, radiological, nuclear, explosive, temperature, humidity, vibration, accelerometry, etc.) and information sources (camera, keypad, PDA, cell phone, satellite phone, hand-held interrogator, RFID reader, etc.). The sensor package may contain a load cell, strain gage, or other means of monitoring tension on a locking bar so that an alarm condition will be triggered if a predetermined condition is met. The device will communicate wirelessly with a sensor node, which detects a variety of constituents and conditions, either permanently or temporarily installed in commercial, industrial, consumer environment or intermodal container, over the road trailer, man-portable case, or enclosed conveyance. The sensor package may include a number of devices performing various security, sensing, and tracking functions.

### EXAMPLE

These devices may be powered by batteries, fuel cells, and the like, and provision may also be made for recharging or maintaining charge via a cradle or an umbilical configured to accept power from a variety of power sources including, but not limited to, power scavenging through solar, kinetic, change of state devices, or radio frequencies.

### EXAMPLE

A GOWMN may be applied to a variety of telematics, sensor network, and machine to machine communications applications. In telematics applications devices (either mobile or fixed) communicate to make decisions in an automated fashion based on conditions or status of individual constituents of the telematics network in industrial, commercial, and consumer applications, including, but not limited to, smart buildings, manufacturing processes, electrical generation facilities and grids, petroleum mining, refining, and pumping/piping facilities, and the like.

It will be appreciated that wireless communication of many varieties including such familiar protocols as serial radio, cellular radio, satellite radio, WiFi, WiMax, OFDM, direct sequence RF, frequency hopping, code division multiplexing (CDMA), frequency division multiplexing (FDMA), and time division multiplexing (TDMA), microwave wireless dishes, etc. can benefit from the GOWMN method and apparatus.

The foregoing examples illustrate an important aspect of the invention, viz., that the system administrator, by having access to reports from a plurality of GOWMN nodes, inherently derives a higher level of situational awareness, and that the resulting information can therefore have significant added value to various clients.

### EXAMPLE

As noted above, a key element of the inventive GOWMN is a geographic location determination solution. Applicants contemplate that under normal operating conditions, the GOWMN will be governed primarily by GPS data. Applicants recognize, however, that means are available to spoof a GPS receiver if an adversary has sufficient resources and is able to position sophisticated RF equipment close enough to the GPS unit. The inventive GOWMN may therefore be optionally equipped with redundant means of cross-checking the GPS data. Some preferred means include the following:

1. Small accelerometers may be used along with a clock to compute the approximate location by dead reckoning. Accelerometers may be incorporated in sensor package.

2. Absolute radiolocation via either or both of time-of-flight or strength-of-signal information from a series of fixed telemetering devices.

5. Inter-device radiolocation creating a relative mapping rather than absolute mapping in absence of GPS and absolute radiolocation.

Some examples of commercial available wireless communications modules include the following: 1. Serial Mesh Radio (e.g.: ZMN2405HP manufactured by RF Monolithics, Inc., 4441 Sigma Road, Dallas, Tex. 75244); 2. Quadband GSM Cellular (e.g., GM862-GPS manufactured by Telit Wireless Solutions, Inc., 3131 RDU Center Drive, Suite 135, Morrisville, N.C. 27560), 3. LEO Satellite (e.g., DS100 manufactured by Stellar Satellite Communications Ltd., 46050 Manekin Plaza, Suite 100, Dulles, Va. 20166). All of the foregoing are suitable in for inclusion in the inventive device in terms of form factor, data conditioning, and power conditioning characteristics.

Some examples of commercial available sensor packages include but are not limited to the following: 1. Angular rate sensors and gyroscopes, (e.g., ADXRS manufactured by Analog Devices, 3 Technology Way, Norwood, Mass. 02062), 2. Pressure sensors (e.g., Flexiforce manufactured by Tekscan, Inc., 307 West First Street, South Boston, Mass. 02127-1309), 3. Magnetometers (e.g., MicroMag manufactured by PNI Sensor Corporation, 133 Aviation Blvd., Suite 101, Santa Rosa, Calif. 95403), 4. Accelerometry (e.g., ADXL manufactured by Analog Devices, 3 Technology Way, Norwood, Mass. 02062). Other sensors such as temperature and humidity sensors, tamper switches, etc. are well known in the art. All of the foregoing are likewise suitable in for inclusion in the inventive device in terms of form factor, data conditioning, antenna configuration, and power conditioning characteristics. Systems known in the art to detect and measure chemical, biological radiological, nuclear, and explosive agents are also suitable for inclusion in the inventive access bar.

There are many suitable commercially available central processing units and microcontrollers; for example, Applicants have found the following device to be suitable for carrying out the invention: ARM9,manufactured by ARM Ltd., 110 Fulbourn Road, Cambridge, UK. This and many similar devices are all suitable for inclusion in the inventive device in terms of form factor, data conditioning, and power conditioning characteristics.

### EXAMPLE

The inventive GOWMN may further be adapted to a less-than-load tracking application via the wireless serial mesh radio for the shipping industry. Individual cargo constituents in the container or the warehouse (individual packages, individual pallets, or the like) may be affixed with a compatible serial radio, which may be a meshing radio, in order to report identification or location across a network to a hierarchical server system in order to aggregate these devices to provide the ability to perform real-time inventory on a suitably equipped facility at any point in its journey.

### EXAMPLE

Another aspect of the GOWMN is to serve as a remote aggregation point for terminals, yards, depots, warehouses, and the like. The aggregation point includes a combination of a serial mesh radio and a satellite uplink or direct access to the internet in order to transmit information on the status, condition, and location of any individual node in the GOWMN. The remote uplink can aggregate these devices to provide the ability to perform real-time inventory of the item(s) in any geographic location.

### EXAMPLE

Another important aspect of the inventive method is a network operation center including a system administration with automated and/or manual systems for aggregating GOWMN information, distributing client information, and performing advanced value-added logistics and risk or threat analysis. As noted above, those skilled in the art will appreciate that this system provides a higher level of situational awareness and a common operational picture from the item, to the network, to the container, to the community, to the region, to the world. This situational awareness not only improves the overall logistics operation, but also can provide key elements of an early warning security system for a variety of chemical, biological, radiological, nuclear, and explosive threats.

Those skilled in the art will appreciate that the inventive GOWMN could be used in many different applications: For example, it could be an integral part of a locking mechanism applied to shipping containers of various sizes and configurations that is activated by geography and one of time, biometrics, or a predetermined access code. It could form a part of an industrial sensing network for manufacturing, inventory, and other processes. It could form a part of a commercial or consumer sensing network for production, inventory, distribution, and other processes.

The inventive system comprises a geographically optimized wireless network. Some characteristics of the GOWMN include: 1.Secure hand-shaking using a variety of information security, encryption, and validation protocols; 2. Scalable to Hybridized Spread Spectrum (HSS) radio format; 3. Automatically finds other related devices within range; 4. Automatically forms communities if two or more related devices are present; 5. “Elects” a spokesman to collect and send relevant information for whole community based on the minimum period settings of each individual of the community

### EXAMPLE

The invention may further use a protocol that is an anti “spoofing” system for Intelligent RFID Tags that prevents malicious attacks from interfering with the normal operation of the invention. The protocol makes use of an on-board circuit to generate a universally unique identification code based on the collected history, geography, and condition of the device. This code becomes part of the distributed intelligence provided by the inventive solution.

One use of the inventive system is within a global intermodal transportation management system consisting of facilities for the capture, storage, retrieval, analysis, and action (alerts, alarms, etc.) of geographic location and condition information in a web-ready/web-friendly data visualization and reporting application. As such, a central system administrator and a large number of GOWMN nodes together form a fully enabled Geographic Information System (GIS) with customized industry specific applications build around the GIS core/platform. A web-based tracking service may provide real-time access to asset location and condition, automated customized alerts, and content for client needs accessible from any internet-enabled terminal globally. Logistics information can be pulled or pushed directly from the site into the user's internal resource management system. The inventive system may be further enhanced with custom, value-added client services to augment the functionality of the basic tracking system. Intelligent information systems—capable of analyzing geostatistical and geospatial information and patterns (e.g. Geographic Information Systems) to create Strategic Asset Intelligence. 6. Advanced battery technology—battery life exceeding three years.

The preferred capabilities of the inventive system include the following: 1. Secure wireless communications system—the information transmitted via wireless and wired networks must be protected to prevent eavesdropping (e.g. physical layer security, data scrambling, encryption, authentication, etc.). 2. Real-time location—GPS, dead reckoning, or other location based technologies providing the ability to pinpoint assets in real-time under harsh multipath conditions represents a substantial increase in efficiency for port, ship, and warehouse management justifying rapid return on investment. 3. Intelligence fusion—a Common Operational Picture (COP) with real-time alert capability. 4. Network security—multi-layer security scheme for asset tracking and analysis. 5. Multi-user access scheme—wireless devices must have the ability to communicate simultaneously with large numbers of nodes per network (>1000) in a given area to accommodate the numbers of containers in close proximity in modern shipping terminals. 6. Globally available unlicensed radio frequency—need for a single unlicensed RF band to insure interoperability in local area networking and RFID applications or frequency and protocol agile RFID systems.

It will be appreciated that the system relies on wireless communications in various ways. There are three basic approaches to robust wireless RFID communications under harsh multipath environments, viz., Peer-to-peer (mesh networking) solutions, Ultra Wideband solutions; and, Hybridized Spread Spectrum solutions. Applicants prefer the Hybridized Spread Spectrum (HSS) solution because it best stands to holistically address the performance specifications of a global asset tracking and control system: The HSS approach allows for a narrow-spectrum, broad band solution to be engineered to, e.g., a 2.45 GHz frequency (high data rates and higher resistance to environmental conditions), which is the only emerging globally available unlicensed band at the moment providing for robust wireless communications under harsh multipath interference conditions, the traditional barrier to wireless communications. The state-of-the-art in HSS technology constitutes a superior anti-collision wireless communications solution based on the utilization of time sequencing (increased volume for multi-user access), fast frequency hopping (superior resistance to multipath interference), and direct sequence spread spectrum (superior resistance to interference from and two other RF applications in the same geographic area) protocols combined in a unique way and incorporating advanced signal processing concepts.

In essence, the HSS system is able to distinguish the original signal from short-range multipath reflections. The statistical probability of successful communication on the first attempt is 99.99 percent at the bit level with the HSS approach. This network reliability level reduces the need for redundant transmission thereby increasing battery life over currently available commercial technologies. Based on the narrow band solution that is virtually immune to multipath interference, the system will support radiolocation (1 meter 3 dimensional accuracy in real-time) to be performed on individual tags in the standard stacking conditions of shipping containers in a port, on a ship, in the hold of a ship, and in warehouses. The HSS solution can create a GOWMN intelligently switching modes depending on the nature of the environment based on the radiolocation and transceiver architecture (each tag is a reader and a transmitter). The time sequencing aspects of the HSS solution has the potential to support two-way communication with up to 10,000 individual tags per Reader unit in every 100-second window, which is critical in the maritime ship and port environment. The end result is a robust multi-user active RFID wireless tracking and communication solution with inherent security at the physical layer (based on the way the waveform is generated) upon which encryption, data scrambling, and authentication security can be layered. For these reasons, the HSS approach appears to be the most logical and tenable solution to a globally deployed RFID total asset visibility solution.

We claim:

1. A wireless mesh network comprising:
a plurality of peer devices in communication with one another and having the ability to forward selected information across the network to a backhaul, each of said peer devices further comprising a geographic information system to determine the location of said peer device; and,
at least one network device that adjusts at least a part of the network topology based on the mapped location of said peer devices.

2. The mesh network of claim 1 wherein at least some of said peer devices are mobile.

3. The mesh network of claim 1 wherein each of said peer devices further includes at least one device selected from the following group: sensors; accelerometers; and RFID tags.

4. The mesh network of claim 1 wherein said geographic information system comprises a GPS device.

5. The mesh network of claim 1 wherein said network device comprises a server.

6. The mesh network of claim 1 wherein at least some of said peer devices adjust at least a part of said network topology.

7. The mesh network of claim 1 wherein said adjustment of said network topology comprises an action selected from the following group: adjustment of sleep/wake cycle for at least one of said peer devices; toggling at least one of said peer devices between master and slave functions; and managing the number of communication pathways.

8. The mesh network of claim 1 wherein said backhaul system provides a global aggregation of data and location information from said plurality of peer devices.

9. A wireless mesh network comprising:
a plurality of peer devices forming network nodes in communication with one another and each having at least one sensor to sense at least one condition affecting an item associated with said network node, each peer device further comprising a geographic information system to determine the location of said peer device; and,
a system monitor, located remotely from said peer devices, said system monitor adjusting at least a part of the network topology based on the mapped location of said peer devices so that communication efficiency may be optimized.

10. The mesh network of claim 9 wherein said system monitor performs a global aggregation of location, status, and condition of items associated with each of said network nodes respectively.

11. The mesh network of claim 9 wherein said sensor comprises a device selected from the following group: chemical sensors; biological sensors; radiological sensors; explosive detectors; temperature sensors; humidity sensors; vibration sensors; accelerometers; and RFID tags.

12. The mesh network of claim 9 wherein any individual node can be dynamically toggled between master and slave function, with the master reporting for any number of slave or master devices in a hierarchical daisy-chain configuration.

13. The mesh network of claim 9 wherein said network controller can assign to individual nodes of the radio network one of the following: time slices and time sequencing.

14. A network controller server system for a geographically optimized wireless mesh network (GOWMN) comprising:
a computational computer platform for the storage, retrieval, analysis, and presentation of data regarding geographic information;
a first geographic information system application to determine the location and topology of GOWMN nodes;
a second geographic information system application to configure the optimal network topology and push said topology information to the GOWMN network;
an algorithm for determining localized time sequencing and time slicing for any GOWMN network/subnetwork; and,
a system monitor to receive information from said network controller at selected times and provide said output to selected users.

15. A method of operating a wireless mesh network comprising the steps of:
creating a network of peer devices, each peer device forming a node in said network, each peer device further comprising a geographic information system so that the physical location of each peer device is known;
establishing a first network topology based on the respective locations of said peer devices; and,
dynamically adjusting said topology to optimize communication efficiency.

16. The method of claim 15 wherein each of said peer devices includes a microprocessor capable of analyzing the location of said device and using said location and network topology to determine an optimized communications path.

17. The method of claim 16 further including the step of:
aggregating data from said peer devices into a secure, web-based aggregation system through which selected users can manage assets, processes, and networks in real-time via the Internet.
